(19) United States
(12) Patent Application Publication
(10) Pub. No.: US 2011/0175897 A1
(43) Pub. Date: Jul. 21, 2011

(54) PIXEL STRUCTURE, DISPLAY PANEL, DISPLAY AND DRIVING METHOD THEREOF

(75) Inventors: Ming-Chun TSENG, Tainan County (TW); Hung-Lin HSU, Tainan County (TW); Lien-Hsiang CHEN, Tainan County (TW); Hong-Ru GUO, Tainan County (TW)

(73) Assignees: CHIMEI INNOLUX CORPORATION, Miao-Li County (TW); CHI MEI OPTOELECTRONICS CORP., Tainan County (TW)

(21) Appl. No.: 12/879,658

(22) Filed: Sep. 10, 2010

(30) Foreign Application Priority Data
Jan. 19, 2010 (TW) 99101402

(51) Int. Cl. G09G 3/32; G09G 5/00

(52) U.S. Cl. 345/213; 345/76

(57) ABSTRACT

A pixel structure, a display panel, a display and a driving method thereof are disclosed. The pixel structure comprises an organic light emitting diode, a driving transistor, a storage capacitance, and a switch transistor. A first terminal of the driving transistor receives an image retention cancellation signal. The image retention cancellation signal changes to a second level from a first level before the driving transistor drives the organic light emitting diode so that the driving transistor is operated in a forward curve. A second terminal of the driving transistor is coupled to the light emitting diode. One terminal of the storage capacitance receives a common voltage, and the other terminal of the storage capacitance is coupled to a control terminal of the driving transistor. The switch transistor is controlled by a scan signal to output a data signal to the control terminal of the driving transistor.

This application claims the benefit of Taiwan application Serial No. 99101402, filed Jan. 19, 2010, the subject matter of which is incorporated herein by reference.

### BACKGROUND OF THE INVENTION

1. Field of the Invention

The invention relates in general to a pixel structure, a display panel, a display and a driving method thereof, and more particularly to an organic light emitting diode (OLED) pixel structure, a display panel, a display and a driving method thereof.

2. Description of the Related Art

Referring to FIG. 1, a forward curve and a backward curve of a P-type transistor are illustrated. The forward curve 110 shows the correspondence relationship between the channel current Id and the gate-source voltage Vgs when the P-type transistor changes to the turn-on state from the turn-off state. The backward curve 120 shows the correspondence relationship between the channel current Id and the gate-source voltage Vgs when the P-type transistor changes to the turn-off state from the turn-on state. The same gate-source voltage Vgs of the forward curve 110 and the backward curve 120 corresponds to different channel currents Id. That is, the magnitude of the current Id depends on whether the transistor is operated in the forward curve 110 or the backward curve 120, and such dependency may result in image retention easily.

Referring to both FIG. 2 and FIG. 3. FIG. 2 shows a circuit diagram of a first type of conventional pixel. FIG. 3 shows a signal timing diagram of FIG. 2. The conventional pixel 20 comprises an organic light emitting diode (OLED) D1, a capacitor C1, a capacitor C2, a driving transistor TFT_DRI, a switch transistor TFT_SW and a switch transistor TFT_SW2. The switch transistor TFT_SW is controlled by the scan signal Sn to output a data signal Data to a control terminal of the driving transistor TFT_DRI. The switch transistor TFT_SW further generates a channel current according to the voltage difference between the data signal Data and the voltage Vdd. One terminal of the capacitor C1 receives the voltage Vdd, and the other terminal of the capacitor C1 is coupled to the control terminal of the driving transistor TFT_DRI. One terminal of the capacitor C2 is coupled to the control terminal of the driving transistor TFT_DRI, and the other terminal of the capacitor C2 receives a previous scan signal Sn−1. The switch transistor TFT_SW2 is controlled by an inverse signal S̅n̅−̅1̅ of the previous scan signal Sn−1 to output the channel current generated by the driving transistor TFT_DRI to the organic light emitting diode D1. However, the conventional pixel 20 drives the organic light emitting diode D1 with 3 P-type transistors, hence decreasing the aperture rate of the display panel.

Referring to both FIG. 4 and FIG. 5. FIG. 4 shows a circuit diagram of a second type of conventional pixel. FIG. 5 shows a signal timing diagram of FIG. 4. The conventional pixel 40 is different from the conventional pixel 20 in that the conventional pixel 40 does not use the switch transistor TFT_SW2, but directly connect the driving transistor TFT_DRI to the organic light emitting diode D1 instead. Since the potential of the control terminal of the driving transistor TFT_DRI boosts due to the inverse signal S̅n̅−̅1̅ of the previous scan signal Sn−1, the scan signal Sn needs to increases the amplitude to assure the normal operation of the switch transistor TFT_SW. By doing this, the range of the output voltage of the scan driver needs to be increased to assure the normal operation of the switch transistor TFT_SW.

### SUMMARY OF THE INVENTION

The invention is directed to a pixel structure, a display panel, a display and a driving method thereof, not only reducing the number of transistors but also decreasing the range of the output voltage of the scan driver.

According to a first aspect of the present invention, a pixel structure comprising an organic light emitting diode (OLED), a driving transistor, a storage capacitance, and a switch transistor is disclosed. A first terminal of the driving transistor receives an image retention cancellation signal. The image retention cancellation signal changes to a second level from a first level so that the driving transistor is operated in a forward curve before the driving transistor drives the light emitting diode (LED). A second terminal of the driving transistor is coupled to the light emitting diode. One terminal of the storage capacitance receives a common voltage, and the other terminal of the storage capacitance is coupled to a control terminal of the driving transistor. The switch transistor is controlled by a scan signal to output a data signal to the control terminal of the driving transistor.

According to a second aspect of the present invention, a display panel comprising at least one scan signal line, at least one data signal line, and at least one pixel is disclosed. The scan signal line is for transmitting a scan signal, and the data signal line is for transmitting a data signal. The pixel comprises an organic light emitting diode, a driving transistor, a storage capacitance, and a switch transistor. A first terminal of the driving transistor receives an image retention cancellation signal. The image retention cancellation signal changes to a second level from a first level before the driving transistor drives the organic light emitting diode so that the driving transistor is operated in a forward curve. A second terminal of the driving transistor is coupled to the light emitting diode. One terminal of the storage capacitance receives a common voltage, and the other terminal of the storage capacitance is coupled to a control terminal of the driving transistor. The switch transistor is controlled by a scan signal to output a data signal to the control terminal of the driving transistor.

According to a third aspect of the present invention, a display comprising a display panel, a scan driver and a data driver is disclosed. The display panel comprises at least one scan signal line, at least one data signal line, and at least one pixel. The scan signal line is for transmitting scan signal, and the data signal line is for transmitting a data signal. The pixel comprises an organic light emitting diode, a driving transistor, a storage capacitance, and a switch transistor. A first terminal of the driving transistor receives an image retention cancellation signal. The image retention cancellation signal changes to a second level from a first level before the driving transistor drives the organic light emitting diode so that the driving transistor is operated in a forward curve. A second terminal of the driving transistor is coupled to the light emitting diode. One terminal of the storage capacitance receives a common voltage, and the other terminal of the storage capacitance is coupled to a control terminal of the driving transistor. The switch transistor is controlled by a scan signal to output a data signal to the control terminal of the driving transistor. The scan driver is for providing the scan signal, and the data driver is for providing the data signal.

According to a fourth aspect of the present invention, a driving method of flat display is disclosed. The driving method comprises the following steps. Firstly, an image retention cancellation signal is provided to a first terminal of the driving transistor, wherein a second terminal of the driving transistor is coupled to the light emitting diode, a control terminal of the driving transistor is coupled to the switch transistor and the storage capacitance, and the switch transistor is controlled by the scan signal to output a data signal to the control terminal. Next, the image retention cancellation signal is changed to a second level from a first level before the driving transistor drives the light emitting diode so that the driving transistor is operated in forward curve. Lastly, the light emitting diode is driven.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a forward curve and a backward curve of a P-type transistor;

FIG. 2 shows a circuit diagram of a first type of conventional pixel;

FIG. 3 shows a signal timing diagram of FIG. 2;

FIG. 4 shows a circuit diagram of a second type of conventional pixel;

FIG. 5 shows a signal timing diagram of FIG. 4;

FIG. 6 shows a schematic view of a display;

FIG. 7 shows a circuit diagram of a pixel structure according to an embodiment of the invention;

FIG. 8 shows a signal timing diagram of FIG. 7;

FIG. 9 shows a comparison of image retention between the technology of an embodiment of the invention and the technology of prior art;

FIG. 10 shows a flowchart of a display driving method of an embodiment of the invention.

### DETAILED DESCRIPTION OF THE INVENTION

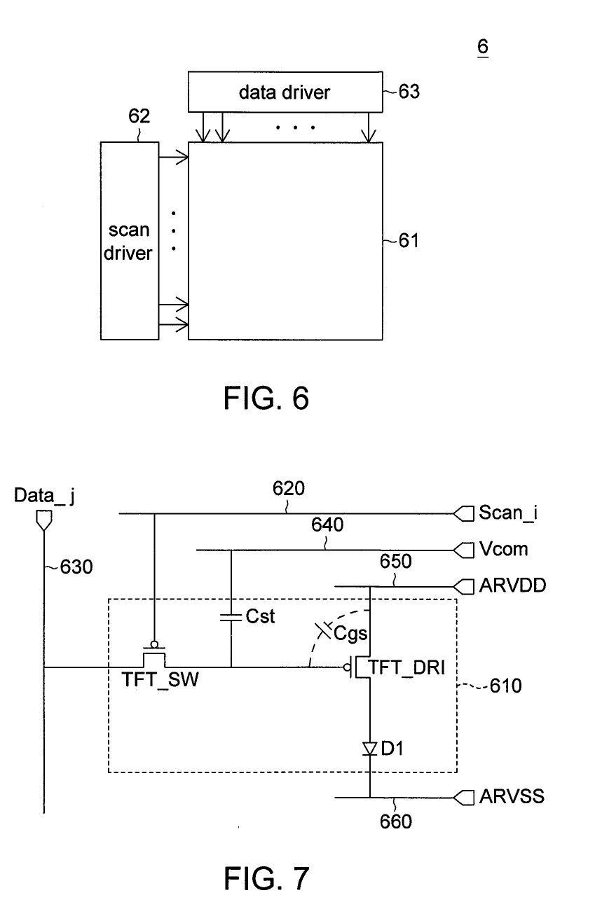

Referring to FIG. 6, a schematic view of a display is shown. The display 6 comprises a display panel 61, a scan driver 62 and a data driver 63. The scan driver 62 and the data driver 63 are for driving the display panel 61.

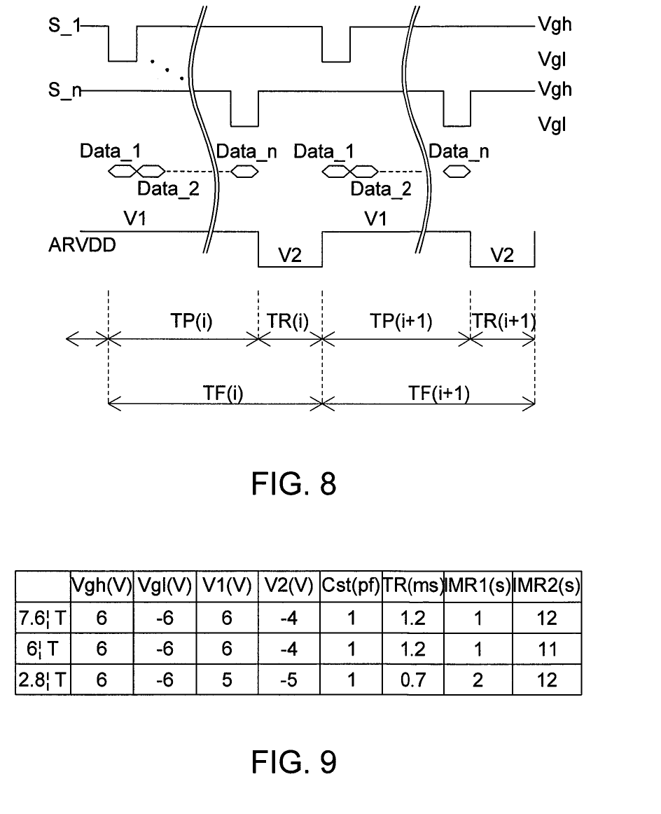

Referring to both FIG. 7 and FIG. 8. FIG. 7 shows a circuit diagram of a pixel structure according to an embodiment of the invention. FIG. 8 shows a signal timing diagram of FIG. 7. The display panel 61 comprises a pixel 610, a scan signal line 620, a data signal line 630, a common voltage signal line 640, an image retention cancellation signal line 650 and a bias-voltage signal line 660. The pixel 610 comprises an organic light emitting diode (OLED) D1, a driving transistor TFT_DRI, a storage capacitance Cst and a switch transistor TFT_SW. The driving transistor TFT_DRI and the switch transistor TFT_SW are both realized by a P-type transistor.

A first terminal of the driving transistor TFT_DRI is coupled to the image retention cancellation signal line 650 to receive an image retention cancellation signal ARVDD, and a second terminal of the driving transistor TFT_DRI is coupled to the anode of the organic light emitting diode D1. The cathode of the organic light emitting diode D1 is coupled to the bias-voltage signal line 660 to receive a bias-voltage ARVSS. One terminal of the storage capacitance Cst is coupled to the common voltage signal line to receive a common voltage Vcom, and the other terminal of the storage capacitance Cst is coupled to a control terminal of the driving transistor TFT_DRI and a second terminal of the switch transistor TFT_SW. A first terminal of the switch transistor TFT_SW is coupled to the data signal line 630 to receive a data signal Data_j, and a control terminal of the switch transistor TFT_SW is coupled to the scan signal line 620 to receive a scan signal Scan_i. The scan signal Scan_i is provided by the scan driver 62, and the data signal Data_j is provided by the data driver 63.

The i^{th} frame time TF(i) comprises a display period TP(i) and a reset period TR(i), wherein the reset period TR(i) is within a blanking time of the display 6. The data signals Data_1˜Data_n are written to the pixel 610 during the display period TP(i), and the data signals Data_1˜Data_n will not be written to the pixel 610 during the reset period TR(i). Likewise, the (i+1)^{th} frame time TF(i+1) comprises a display period TP(i+1) and a reset period TR(i+1), wherein the reset period TR(i+1) is within another blanking time of the display 6. The data signals Data_1˜Data_n are written to the pixel 610 during the display period TP(i+1), but the data signals Data_1˜Data_n will not be written to the pixel 610 during the reset period TR(i+1).

The data signals Data_1˜Data_n respectively correspond to the scan signals S_1˜S_n. The scan signal Scan_i of FIG. 7 is such as one of the scan signals S_1˜S_n of FIG. 8, and the data signal Data_j of FIG. 7 is such as one of the data signals Data_1˜Data_n of FIG. 8. During the display period TP, the switch transistor TFT_SW is controlled by a scan signal Scan_n to output a data signal Data_m to the control terminal of the driving transistor TFT_DRI.

The image retention cancellation signal ARVDD changes to level V2 from level V1 before the driving transistor TFT_DRI drives the light emitting diode (LED) D1 so that the driving transistor TFT_DRI is operated in a forward curve, wherein level V2 lower than level V1. Furthermore, the image retention cancellation signal ARVDD changes to level V2 from level V1 to turn off the driving transistor TFT_DRI during the reset period TR(i) of the i^{th} frame time TF(i) before the driving transistor TFT_DRI drives the light emitting diode D1. The image retention cancellation signal ARVDD changes to level V1 from level V2 to turn on the driving transistor TFT_DRI during the display period TP(i+1) of the (i+1)^{th} frame time TF(i+1) within which the driving transistor TFT_DRI drives the light emitting diode D1. Since the image retention cancellation signal ARVDD assures that the driving transistor TFT_DRI changes to the turn-on state from the turn-off state, the driving transistor TFT_DRI drives the light emitting diode D1 according to the forward curve. Since the driving transistor TFT_DRI is already turned off during the reset period TR(i) of the i^{th} frame time TF(i) before the driving transistor TFT_DRI drives the light emitting diode D1 during the display period TP(i+1) of the (i+1)^{th} frame time TF(i+1), it is assured that the driving transistor TFT_DRI drives the light emitting diode D1 according to a forward curve and image retention will not occur.

The image retention cancellation signal ARVDD is not always at a fixed level, but varies between level V1 and level V2. To avoid the level of the control terminal of the driving transistor TFT_DRI being affected by the change in the level of the image retention cancellation signal ARVDD, the storage capacitance Cst is preferably larger than 10 times of the parasitic capacitance Cgs, wherein the parasitic capacitance Cgs is formed between the first terminal of the driving transistor TFT_DRI and the control terminal of the driving transistor TFT_DRI.

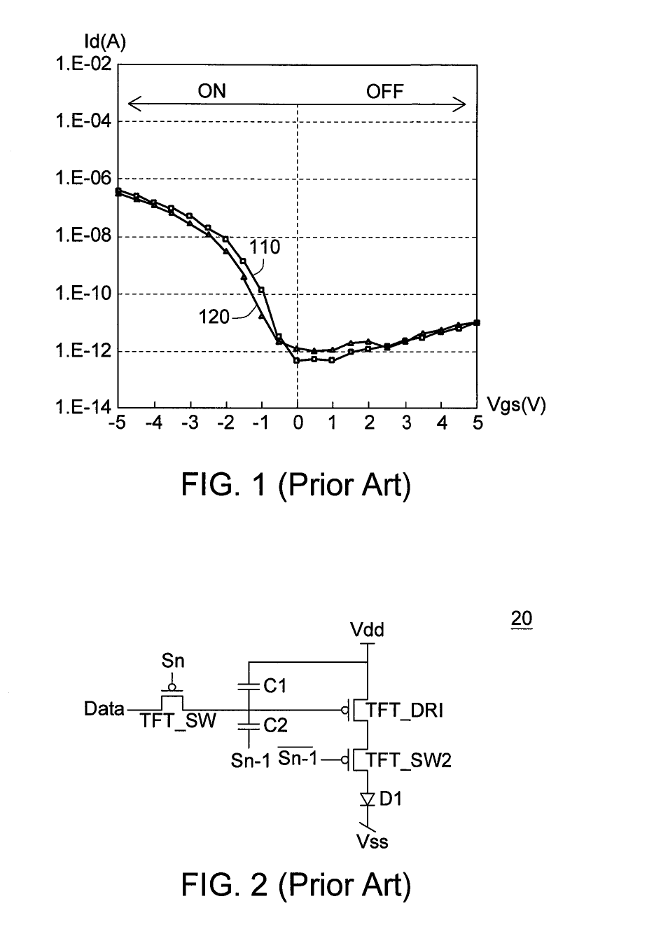

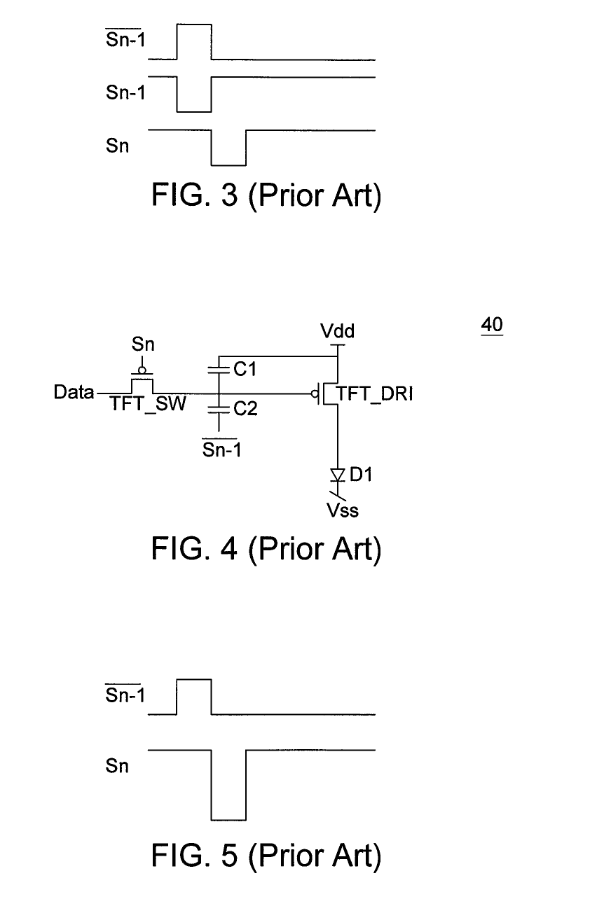

In comparison to the pixel 20 of FIG. 1, the structural design of the pixel 610 uses one less transistor, hence increasing the aperture rate of the display panel 61. In comparison to the pixel 40 of FIG. 4, the range of the output voltage of the scan driver 62 is decreased in the structural design of the pixel 610.

Referring to FIG. 9, a comparison of image retention between the technology of an embodiment of the invention and the technology of prior art is shown. To illustrate the differences in image retention between the technology of an embodiment of the invention and the technology of prior art, a 6-inch and a 2.8-inch flat displays are respectively taken for example in FIG. 9. The image retention IMR2 occurring to a conventional 7.6-inch flat display is about 12 seconds, and the image retention IMR1 occurring to the 7.6-inch flat display of an embodiment of the invention is about 1 seconds. The image retention IMR2 occurring to a conventional 6-inch flat display is about 11 seconds, and image retention IMR1 occurring to the 6-inch flat display of an embodiment of the invention is about 1 second. The image retention IMR2 occurring to a conventional 2.8-inch flat display is about 12 seconds, and the image retention IMR1 occurring to the 2.8-inch flat display of an embodiment of the invention is about 2 seconds. Compared to the conventional technology of the prior art, the embodiment of the invention further improves image retention.

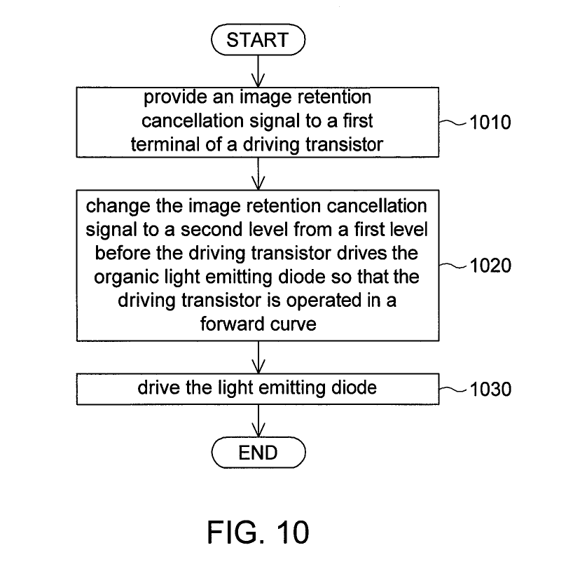

Referring to FIG. 10, a flowchart of a display driving method of an embodiment of the invention is shown. The display driving method is used in such as the display 6, and at least comprises the following steps. Firstly, the method begins at step 1010, an image retention cancellation signal ARVDD is provided to a first terminal of the driving transistor TFT_DRI, wherein a second terminal of the driving transistor TFT_DRI is coupled to the light emitting diode D1, a control terminal of the driving transistor TFT_DRI is coupled to the switch transistor TFT_SW and the storage capacitance Cst, and the switch transistor TFT_SW is controlled by the scan signal Scan_i to output a data signal Data_j to the control terminal. Next, the method proceeds to step 1020, the image retention cancellation signal ARVDD changes to level V2 from level V1 before the driving transistor TFT_DRI drives the light emitting diode D1 so that the driving transistor TFT_DRI is operated in a forward curve. Then, the method proceeds to step 1030, the light emitting diode D1 is driven.

The pixel structure, the display panel and the display disclosed in the above embodiments of the invention have many advantages exemplified below:

Firstly, the number of transistors is reduced.

Secondly, the range of the output voltage of the scan driver is decreased.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pixel structure, comprising:
an organic light emitting diode (OLED);
a driving transistor, comprising:
a first terminal receiving an image retention cancellation signal, which changes to a second level from a first level before the driving transistor drives the light emitting diode (LED) so that the driving transistor is operated in a forward curve;
a second terminal coupled to the light emitting diode;
a control terminal;
a storage capacitance, wherein one terminal of the storage capacitance receives a common voltage, and the other terminal of the storage capacitance is coupled to the control terminal; and
a switch transistor controlled by a scan signal to output a data signal to the control terminal.

2. The pixel structure according to claim 1, wherein the image retention cancellation signal changes to the second level from the first level to turn off the driving transistor during a reset period before the driving transistor drives the organic light emitting diode, and the image retention cancellation signal changes to the first level from the second level to turn on the driving transistor during a display period within which the driving transistor drives the light emitting diode, so that the driving transistor drives the light emitting diode according to the forward curve.

3. The pixel structure according to claim 2, wherein the reset period is within an i^{th} frame time, and the display period is within an (i+1)^{th} frame time.

4. The pixel structure according to claim 2, wherein the reset period is within a blanking time.

5. The pixel structure according to claim 1, wherein the first level is higher than the second level.

6. The pixel structure according to claim 1, wherein the storage capacitance is 10 times larger than a parasitic capacitance, which is formed between the first terminal and the control terminal.

7. The pixel structure according to claim 1, wherein the driving transistor and the switch transistor are both realized by a P-type transistor.

8. The pixel structure according to claim 1, wherein the first terminal is coupled to an image retention (IMR) cancellation signal line.

9. The pixel structure according to claim 1, wherein one terminal of the storage capacitance is coupled to a common voltage signal line.

10. A display driving method, comprising:
providing an image retention cancellation signal to a first terminal of a driving transistor, wherein a second terminal of the driving transistor is coupled to a light emitting diode, a control terminal of the driving transistor is coupled to a switch transistor and a storage capacitance, and the switch transistor is controlled by a scan signal to output a data signal to the control terminal;
changing the image retention cancellation signal to a second level from a first level before the driving transistor drives the organic light emitting diode so that the driving transistor is operated in a forward curve; and
driving the light emitting diode.

11. The driving method according to claim 10, wherein in the step of changing to a second level from a first level, the image retention cancellation signal changes to the second level from the first level to turn off the driving transistor during a reset period before the driving transistor drives the organic light emitting diode.

12. The driving method according to claim 11, wherein in the step of driving the light emitting diode, the image retention cancellation signal changes to the first level from the second level to turn on the driving transistor during a display period within which the driving transistor drives the light emitting diode.

13. The driving method according to claim 12, wherein the reset period is within an i^{th} frame time, and the display period is within an (i+1)^{th} frame time.

14. The driving method according to claim 11, wherein in the step of driving the light emitting diode, the reset period is within a blanking time.

15. The driving method according to claim 10, wherein the first level is higher than the second level.

16. The driving method according to claim 10, wherein the storage capacitance is 10 times larger than a parasitic capacitance, which is formed between the first terminal and the control terminal.

17. The driving method according to claim 10, wherein the driving transistor and the switch transistor are both realized by a P-type transistor.

18. The driving method according to claim 10, wherein the first terminal is coupled to an image retention (IMR) cancellation signal line.

19. The driving method according to claim 10, wherein one terminal of the storage capacitance is coupled to a common voltage signal line
